(19) United States
(12) Patent Application Publication
(10) Pub. No.: US 2008/0235358 A1
(43) Pub. Date: Sep. 25, 2008

(54) Proxy Device, Network System, and Communication Method

(76) Inventors: Hirotaka MORIBE, Yokohama (JP); Mika Mizutani, Tokyo (JP); Shigeki Taira, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/051,257

(22) Filed: Mar. 19, 2008

(30) Foreign Application Priority Data
Mar. 20, 2007 (JP) 2007-072728

(51) Int. Cl. G06F 15/177

(52) U.S. Cl. 709/220

(57) ABSTRACT

The present invention provides a proxy device, a network system, and a communication method to enable communication between an information appliance capable of communicating only within a closed network and an information appliance capable of communicating only within a closed network different from the network, via an open network, wherein in a proxy device 4 capable of transmitting and receiving a message to and from a DLNA-compliant device 6 present in a home network 2, a message which can be communicated within the home network 2 but cannot be communicated to the Internet 3 is encapsulated so as to be communicated to the Internet 3, the encapsulated message is transmitted and received via the Internet 3, and the encapsulated message is decapsulated, and the decapsulated message is transmitted into the home network 2 in which the proxy device 4 itself is present.

### CROSS REFERENCE TO RELATED APPLICATIONS

This application claims the foreign priority benefit under 35 U.S.C. §119 of Japanese Patent Application No. 2007-72728 filed on Mar. 20, 2007, the disclosure of which is incorporated herein by reference.

### BACKGROUND OF THE INVENTION

1. Field of the Invention

The present invention relates to the techniques of a proxy device, a network system, and a communication method.

2. Description of the Related Art

It has become common that various devices for consumers are connected to networks and communicate with each other to mutually provide various functions. With this background, mainly, for the purpose of use within a home network, there are standards called UPnP (Universal Plug & Play: registered trademark) (for example, refer to Non-patent document 1) for realizing various controls via networks without requiring general users to have special knowledge of complicated settings and management for connecting devices to networks. In addition, there is a DLNA (Digital Living Network Alliance: registered trademark) guidelines (for example, refer to Non-patent document 2) using UPnP as a part of protocol for the purpose of sharing contents via networks within a home network.

However, the UPnP and DLNA guidelines (hereinafter, referred to as DLNA as appropriate aims at use mainly in a home network, so that it cannot find or control devices connected via the wide-area Internet.

To solve this problem, there is proposed a technique for realizing a UPnP-enabled device via the wide-area Internet network by virtually reproducing a UPnP-enabled device on a UPnP device proxy device by providing the UPnP device proxy device, scanning each UPnP protocol message, acquiring device information and device service information, and transferring the information to the UPnP device proxy device on another network (for example, refer to Patent document 1).

[Non-patent document 1] UPnP device Architecture Version 1.0.1, [online], May 2003, UPnP Forum, [Searched on Dec. 1, 2006], Internet <URL: http://www.upnp.org>
[Non-patent document 2] Digital Living Network Alliance Home Networked Device Interoperability Guidelines Version 1.0, [online], June 2004, Digital Network Alliance, [Searched on Dec. 1, 2006], Internet <URL: http://www.dlna.org>
[Patent document 1] Japanese Published Unexamined Patent Application No. 2005-311773

However, the technique described in Patent document 1 has the following problems. First, it is necessary that device information and service information of a UPnP-enabled device present in a home network connected via the wide-area Internet are collected by a UPnP device proxy device connected to the home network, and registered in advance in a UPnP device proxy device of a connection destination. The UPnP device proxy device must realize a protocol regulated according to the UPnP as a proxy of a remote UPnP-enabled device.

Second, the protocol to be exchanged between the UPnP device proxy devices is in an original format using SOAP (Simple Object Access Protocol), and message definition and a function for reproducing a UPnP-enabled device by understanding this message are necessary. The UPnP device proxy device is constituted based on the assumption that it is applied to a router.

The present invention was made in view of these circumstances, and an object of the present invention is to enable communication between an information appliance capable of communicating only within a closed network and an information appliance capable of communicating only within another closed network via an open network by a simple means.

### SUMMARY OF THE INVENTION

To solve the problems, the present invention was completed. Specifically, according to the present invention, in a proxy device capable of transmitting and receiving information to and from an information appliance present within a closed network capable of communicating with an open network, information that can be communicated within a closed network but cannot be communicated to an open network is encapsulated so as to be communicated to an open network, and the encapsulated information is transmitted and received via an open network, and the encapsulated information is decapsulated, and the decapsulated information is transmitted into a closed network including the presence of the proxy device itself.

A first aspect of the present invention provides a proxy device which transmits and receives information to and from an information appliance present within a first closed network, the proxy device capable of communicating with an open network, including an encapsulation processor that encapsulates the information that is capable of communication with the first closed network but incapable of communication with the open network, so as to allow the encapsulated information to be capable of communication with the open network; a remote proxy communicator which transmits and receives the encapsulated information via the open network; a decapsulation processor which decapsulates the encapsulated information; and a local communicator which transmits the decapsulated information into the first closed network in which the proxy device itself is located.

A second aspect of the present invention provides a network system for allowing communication via an open network between a first closed network including a first proxy device capable of accessing a first information appliance and

a second closed network including a second proxy device capable of accessing a second information appliance incapable of communicating with the first information appliance, the first proxy device encapsulating information, which is transmitted from the first information appliance and is capable of communication within the first closed network but incapable of communication with the open network, so as to allow the encapsulated information to be capable of communication with the open network; transmitting the encapsulated information to the open network; the second proxy device decapsulating the encapsulated information received via the open network; and transmitting the decapsulated information to the second information appliance to allow communication between the first information appliance and the second information appliance.

A third aspect of the present invention provides a communication method for a plurality of proxy devices capable of transmitting and receiving information to and from information appliances in a plurality of closed networks, the closed networks capable of communicating with one another via an open network, the method including steps of allowing a first proxy device of the plural proxy devices to perform encapsulating the information capable of communication with a first closed network of the closed networks where the first proxy device itself is located but incapable of communicating with the open network, so as to allow the encapsulated information to be communicated with the open network, transmitting the encapsulated information to a second proxy device of the plural proxy devices via the open network; and allowing the second proxy device which receives the encapsulated information to perform decapsulating the encapsulated information, and transmitting the decapsulated information to a second closed network of the closed networks where the second proxy device itself is located.

According to the present invention, communication between an information appliance capable of communicating only within a closed network and an information appliance capable of communicating only within another closed network, via an open network, is enabled by a simpler means.

Other features and advantages of the present invention will become more apparent from the following detailed descriptions of the invention when taken in conjunction with the accompanying drawings.

### DESCRIPTION OF THE DRAWINGS

FIG. 1 is a diagram showing a configuration example of a network system of an embodiment of the present invention.

FIG. 2 is a functional block diagram of a proxy device of the embodiment.

FIG. 3 is a diagram showing a configuration example of hardware of the proxy device of the embodiment.

FIG. 4A is a sequence diagram showing a flow of a processing example of a communication method by the network system of the embodiment (No. 1).

FIG. 4B is a sequence diagram showing a flow of a processing example of a communication method by the network system of the embodiment (No. 2).

FIG. 5 is a flowchart showing a flow of a search message encapsulation processing example of Step S1 of FIG. 4A.

FIG. 6 is a diagram showing a detailed example of a search message transmitted from a DLNA-compliant device at Step S101 of FIG. 5.

FIG. 7 is a diagram showing a detailed example of the search message encapsulated at Step S102 of FIG. 5.

FIG. 8 is a flowchart showing a flow of a DLNA local search processing example at Step S2 of FIG. 4A.

FIG. 9 is a diagram showing an example of a search response transmitted from a DLNA-compliant device at Step S205 of FIG. 8.

FIG. 10 is a diagram showing a detailed example of the search response encapsulated at Step S206 of FIG. 8.

FIG. 11 is a flowchart showing a flow of a search response local transmission processing example at Step S3 of FIG. 4A.

FIG. 12 is a diagram showing a detailed example of the search response including the position identifier converted at Step S303 of FIG. 11.

FIG. 13 is a flowchart showing a flow of UPnP acquiring request encapsulation processing at Step S4 of FIG. 4A.

FIG. 14 is a diagram showing an example of the UPnP acquiring request received at Step S401 of FIG. 13.

FIG. 15 is a diagram showing an example of the UPnP acquiring request encapsulated at Step S403 of FIG. 13.

FIG. 16 is a flowchart showing a flow of a UPnP information acquisition processing example at Step S5 of FIG. 4A.

FIG. 17 is a diagram showing an example of the UPnP acquiring request after the position identifier is converted at Step S503 of FIG. 16.

FIG. 18 is a flowchart showing a flow of a UPnP acquiring response local transmission processing example at Step S6 of FIG. 4A.

FIG. 19 is a flowchart showing a flow of a contents acquiring request encapsulation processing example of Step S7 of FIG. 4B.

FIG. 20 is a flowchart showing a flow of a contents data acquisition processing example at Step S8 of FIG. 4B.

FIG. 21 is a flowchart showing a flow of a contents data response local transmission processing example of Step S9 of FIG. 4B.

### DESCRIPTION OF THE PREFERRED EMBODIMENTS

Next, a best mode (referred to as “embodiment”) for carrying out the present invention will be described in detail with reference to the drawings as appropriate.

### (System Configuration)

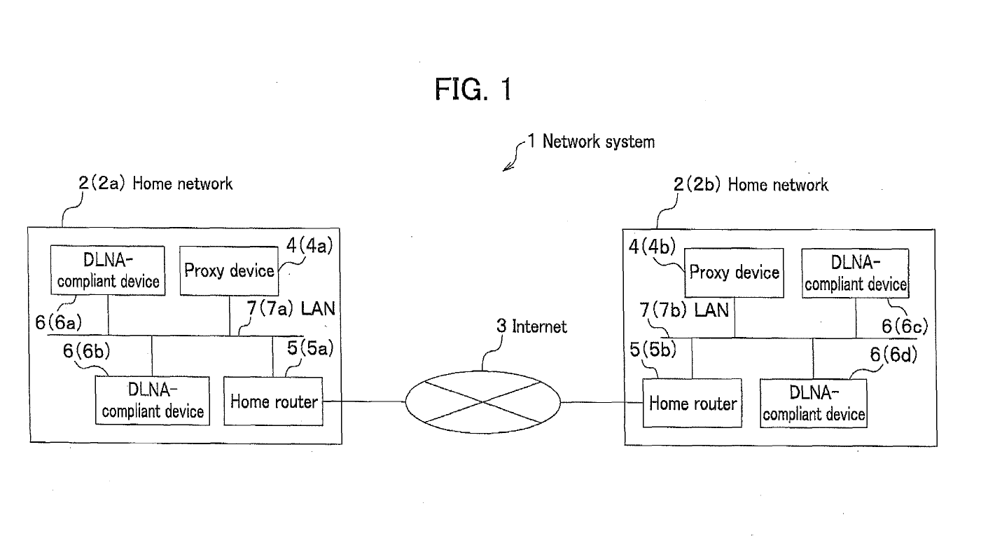

FIG. 1 shows a configuration example of a network system according to this embodiment.

In the network system 1, a home network 2 (2a) (closed network) and a home network 2 (2b) are connected via the Internet 3 (open network).

To the home networks 2a and 2b, proxy devices 4 (4a, 4b), home routers 5 (5a, 5b), and DLNA-compliant devices 6 (6a through 6d) are connected via LANs (Local Area Networks) 7 (7a, 7b), respectively. The home network 2a and the home network 2b are connected to the Internet 3 via the home router 5a and the home router 5b, respectively.

The proxy device 4 can be installed in a television and a hard disk recorder having a communication function, a personal computer, and a mobile terminal such as a mobile player and a mobile phone which are capable of reproducing video images and music excellent in portability, and software conforming to the UPnP and DLNA guidelines may be installed on the proxy device 4.

The home router 5 has an address converting function such as NAT (Network Address Translator), and is set so as to transfer data to the proxy device 4 when receiving the data for a specific port. The DLNA-compliant device 6 is, for example, a hard disk recorder, television, printer having a communication function, or a mobile terminal such as a mobile player or a mobile phone that is capable of reproducing video images and music excellent in portability, or a personal computer, etc., that supports a protocol determined according to the UPnP or DLNA guidelines. The LAN 7 is configured by using an Ethernet (registered trademark), telephone line, electric line, wireless, or infrared communication circuit.

In this embodiment, for simple description, the number of home networks 2 connected to the Internet 3 is set to 2, however, without limiting to this, three or more home networks 2 can be connected thereto.

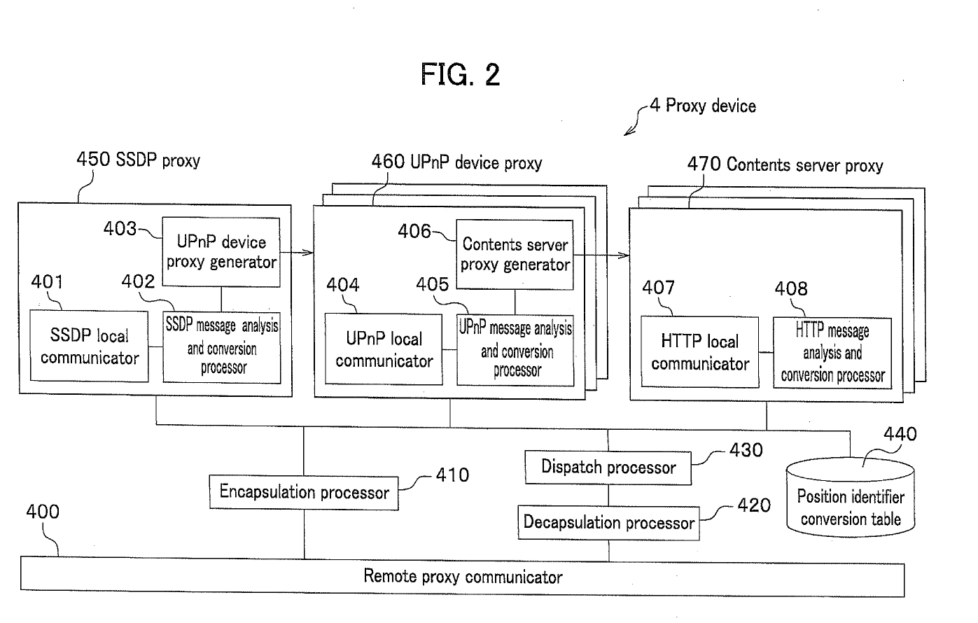

FIG. 2 is a functional block diagram of the proxy device according to this embodiment.

The proxy device 4 includes a remote proxy communicator 400, an encapsulation processor 410, a decapsulation processor 420, a dispatch processor 430, a position identifier conversion table 440, an SSDP (Simple Service Discovery Protocol) proxy 450, UPnP device proxies 460 to be dynamically generated, and contents server proxies 470 to be dynamically generated. The SSDP is a protocol which is regulated according to the specifications of the UPnP and used for finding devices.

The remote proxy communicator 40 has a function of communicating with the home router 5 of the home network 2 connected via the Internet 3.

The encapsulation processor 410 encapsulates a message (hereinafter, referred to as a DLSNA message as appropriate) regulated according to the UPnP or DLNA guidelines to be exchanged in each home network 2 by adding to the message an original header described later. The header to be added includes a protocol name of the encapsulated message such as SSDP, UPnP, or DLNA, a position identifier including an address and a port number of a DLNA-compliant device 6 which originally transmitted the message, and information on the position identifier including an address and a port number of an DLNA-compliant device 6 as an original destination of the message if they are known. In addition, as the header to be added, an identifier for the dispatch processor 430 to perform dispatch processing is added as appropriate.

The decapsulation processor 420 parses, stores, and removes the header added by the encapsulation processor 410 of the proxy device 4 present in another home network 2.

The dispatch processor 430 has a function of distributing data to an appropriate SSDP proxy 450, UPnP device proxy 460, or contents server proxy 470 based on information included in the header added for encapsulating the SSDP message, UPnP message, or DLNA message.

The position identifier conversion table 440 has a function of storing correspondence between position identifiers before and after being converted when an SSDP message analysis and conversion processor 402, UPnP message analysis and conversion processor 405, or HTTP message analysis and conversion processor 408, etc., described later converts position identifiers such as a URL, IP address, and a port number in the message regulated according to the UPnP or DLNA guidelines. This correspondence is referred to by the dispatch processor 430 when performing dispatch processing.

The SSDP proxy 450 processes an SSDP message flowing in the LAN 7 and an SSDP message which was transmitted or received by the remote proxy communicator 400 and decapsulated by the decapsulation processor 420. The SSDP proxy 450 has an SSDP local communicator 401, an SSDP message analysis and conversion processor 402, and a UPnP device proxy generator 403. The SSDP local communicator 401 transmits and receives (locally transmits and receives) an SSDP message received from the LAN 7. The SSDP message analysis and conversion processor 402 searches for position identifiers included in an SSDP message which was received by the remote proxy communicator 400 and from which an encapsulated header was removed by the decapsulation processor 420, and converts these into position identifiers that can be communicated in the home network 2 to which the SSDP message analysis and conversion processor is connected, without overlapping. The number of position identifiers before being converted and the number of position identifiers after being converted coincide with each other, and information on these are stored in the position identifier conversion table 440. The UPnP device proxy generator 403 dynamically generates UPnP device proxies 460 for processing a message regulated according to UPnP in accordance with the address and port number that have been converted by the SSDP message analysis and conversion processor 402.

The UPnP device proxies 460 perform processing for a message except for SSDP, regulated according to UPnP. One of the UPnP device proxies 460 is present from the initial state and is for request, and others are for response and are generated for as many as the position identifiers converted by the SSDP message analysis and conversion processor 402. The UPnP device proxy 460 for request has a function of processing a UPnP acquiring request received via the remote proxy communicator 400. On the other hand, the UPnP device proxies 460 for response have a function of processing a UPnP acquiring response.

The UPnP device proxy 460 includes a UPnP local communicator 404, a UPnP message analysis and conversion processor 405, and a contents server proxy generator 406. The UPnP local communicator 404 has a function of transmitting and receiving (locally transmitting and receiving) a UPnP message to and from the DLNA-compliant device 6 connected via the LAN 7. The UPnP message analysis and conversion processor 405 searches for position identifiers included in a UPnP message which was received by the remote proxy communicator 400 and from which an encapsulated header was removed by the decapsulation processor 420, and converts these into position identifiers that can be communicated in the home network 2 to which the UPnP message analysis and conversion processor is connected without overlapping. The number of position identifiers before being converted and the number of position identifiers after being converted coincide with each other, and the UPnP device proxy 460 other than the UPnP device proxy for standby being present from the initial state, dynamically generates contents server proxies 470 which perform message processing for contents transfer in accordance with the address and port number converted by the UPnP message analysis and conversion processor 405. In the UPnP device proxy 460 for request being present from the initial state, the contents server proxy generator 406 does not operate.

The contents server proxies 470 perform processing of a message relating to contents transfer regulated according to the DLNA guidelines. One of the contents server proxies 470 is present from the initial state and is for request, and other contents server proxies are for response and are generated for as many as the position identifiers converted by the UPnP message analysis and conversion processor 405. The contents server proxy 470 for request has a function of processing a contents acquiring request. On the other hand, the contents server proxies 470 for response have a function of processing a contents data response.

The contents server proxy 470 consists of an HTTP (Hypertext Transfer Protocol) local communicator 407, and an HTTP message analysis and conversion processor 408. The HTTP local communicator 407 transmits and receives (locally transmits and receives) a message relating to contents transfer in DLNA to and from the DLNA-compliant device 6 connected via the LAN 7. The HTTP message analysis and conversion processor 408 searches for position identifiers included in the message relating to contents transfer that were received by the remote proxy communicator 400 and from which an encapsulated header was removed by the decapsulation processor 420, and converts these into position identifiers that can be communicated in a directly connected home network 2.

The SSDP local communicator 401, the UPnP local communicator 404, and the HTTP local communicator 407 may also be referred to as a local communicator.

The SSDP message analysis and conversion processor 402, the UPnP message analysis and conversion processor 405, and the HTTP message analysis and conversion processor 408 may be referred to as a position identifier conversion processor.

The UPnP device proxy generator 403 of the UPnP device proxy 460 for response and the contents server proxy generator 406 of the contents server proxy 470 for response may also be referred to as a processing generator.

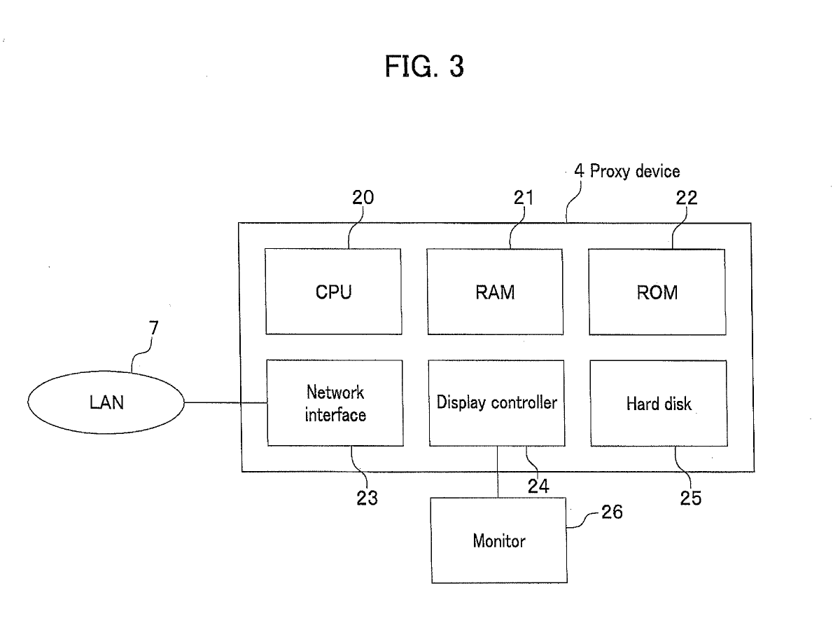

FIG. 3 shows a configuration example of hardware of the proxy device of this embodiment.

The proxy device 4 includes a CPU 20 which controls the entirety of the proxy device 4, a RAM (Random Access Memory) 21 and ROM (Read-Only Memory) 22 for storing data and programs, a network interface 23 which transmits and receives data flowing in the LAN 7, a display controller 24 which performs control for displaying information on a connected monitor 26, and a hard disk 25 which data can be recorded on and deleted from. Depending on the form of the proxy device 4 shown in FIG. 2, the display controller 24 and the hard disk 25 may not be provided. The hard disk 25 may be a separate external storage device.

The units 400 through 408, 410, 420, 430, 450, 460, and 470 shown in FIG. 2 are embodied by developing programs stored on the hard disk 25 and the ROM 22 into the RAM 21 and executing these by the CPU 20.

### (System Processing)

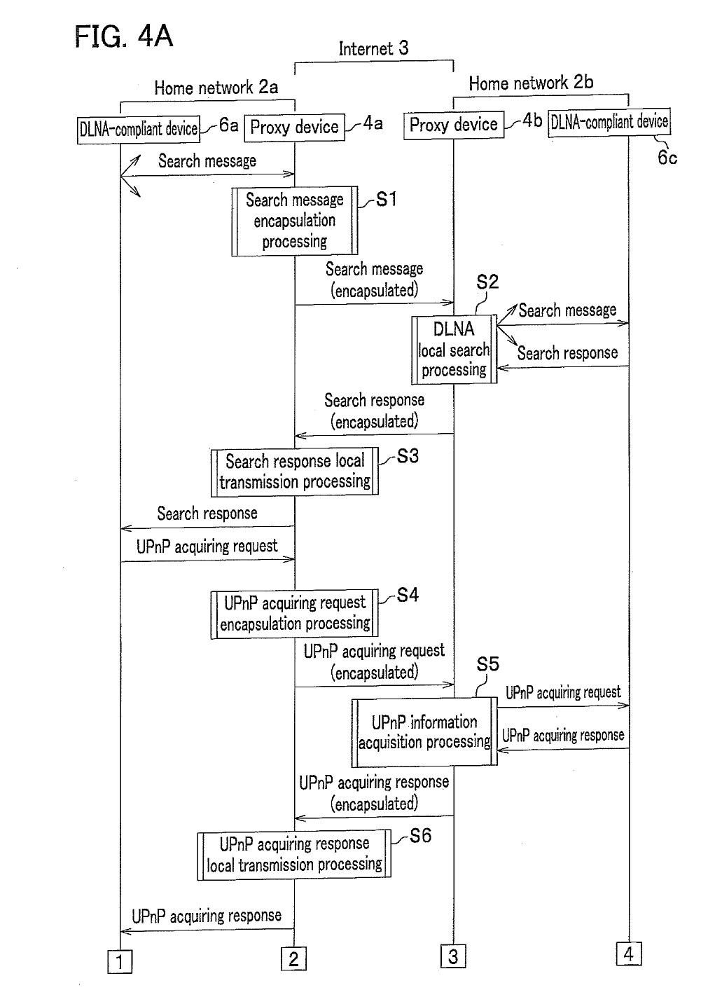

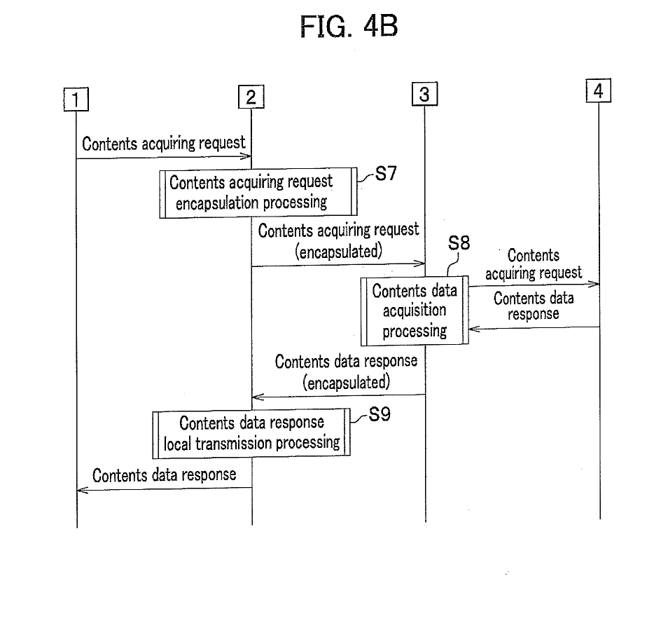

Next, a processing example of the communication method of this embodiment will be described based on FIG. 4 (FIG. 4A and FIG. 4B) through FIG. 21 while referring to FIG. 1 and FIG. 2.

In the following description, communication between the proxy device 4a and the DLNA-compliant device 6a is made via the home network 2a (LAN 7a). Similarly, communication between the proxy device 4b and the DLNA-compliant device 6c is made via the home network 2b (LAN 7b), and communication between the proxy device 4a and the proxy device 4b is made via the home router 5a, the Internet 3, and the home router 5b. The home routers 5a and 5b are omitted in FIG. 4A and FIG. 4B.

In this embodiment, communications among the DLNA-compliant device 6a, the proxy device 4a, the proxy device 4b, and the DLNA-compliant device 6c are described as examples for the convenience of the description, however, the communications are not limited to the communications among these devices.

FIG. 4 (FIG. 4A and FIG. 4B) are sequence diagrams showing a flow of the processing example of the communication method by the network system of this embodiment.

In FIG. 4 (FIG. 4A and FIG. 4B), the same components as in FIG. 1 are attached with the same reference numerals and description thereof is omitted.

First, FIG. 4A will be described.

First, the DLNA-compliant device 6a which requests contents, etc., multicast-transmits in the home network 2a a search message for searching for the DLNA-compliant device 6 which will provide contents thereto. In FIG. 4A and FIG. 4B, when a plurality of arrows start from the same position, this indicates multicast transmission in the same home network 2.

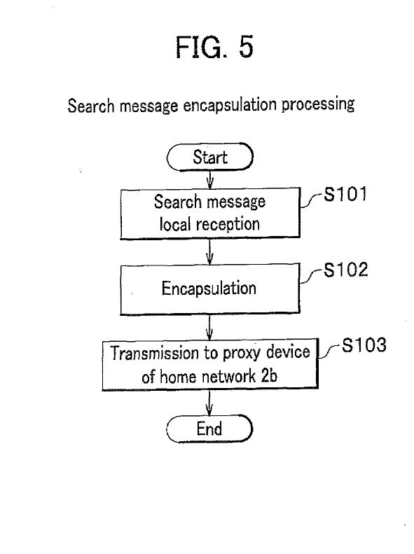

The proxy device 4a which received the search message multicast-transmitted from the DLNA-compliant device 6a performs search message encapsulation processing to encapsulate the received search message (S1: described later by referring to FIG. 5).

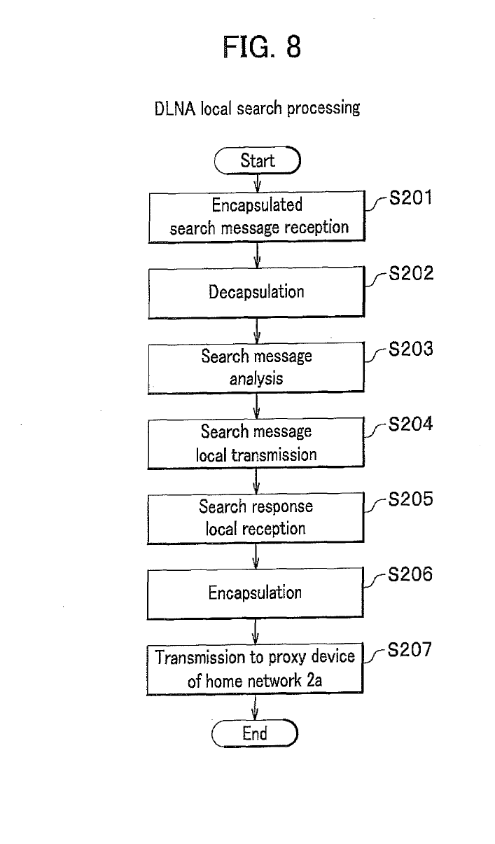

The proxy device 4a transmits the encapsulated search message to the Internet 3. The proxy device 4b which received the encapsulated search message performs DLNA local search processing (S2: described later by referring FIG. 8). Herein, the local search is processing for searching for a corresponding device inside the home network 2b in which the proxy device 4b is located. At Step S2, the proxy device 4b decapsulates the received search message and multicast-transmits the search message in the home network 2b to the DLNA-compliant device 6 in the home network 2b. Then, the DLNA-compliant device 6c corresponding to the search message request replies with a search response to the proxy device 4b. Then, the proxy device 4b encapsulates this search response and transmits it to the Internet 3.

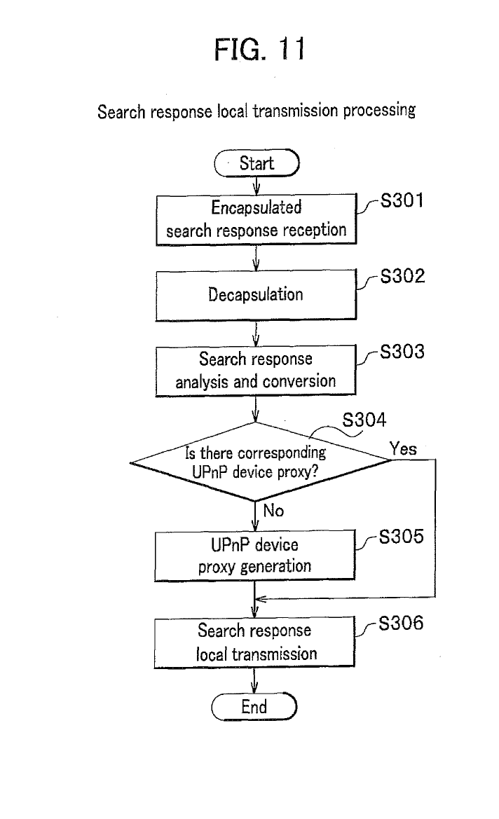

The proxy device 4a which received the encapsulated search response performs search response local transmission processing (S3: described later by referring to FIG. 11). Herein, the local transmission processing is transmission of information in the home network 2 in which the proxy device itself is located. The proxy device 4a transmits the search response decapsulated at step S3 to the DLNA-compliant device 6a.

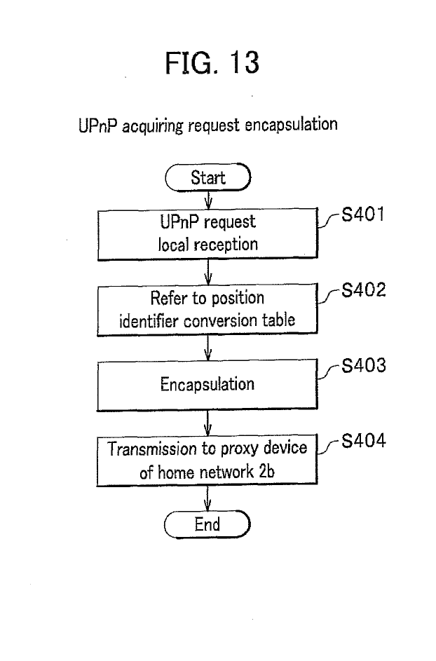

The DLNA-compliant device 6a which received the search response transmits a UPnP acquiring request to the proxy device 4a. The proxy device 4a performs UPnP acquiring request encapsulation processing to encapsulate the received UPnP acquiring request (S4: described later by referring to FIG. 13). The proxy device 4a transmits the encapsulated UPnP acquiring request to the Internet 3.

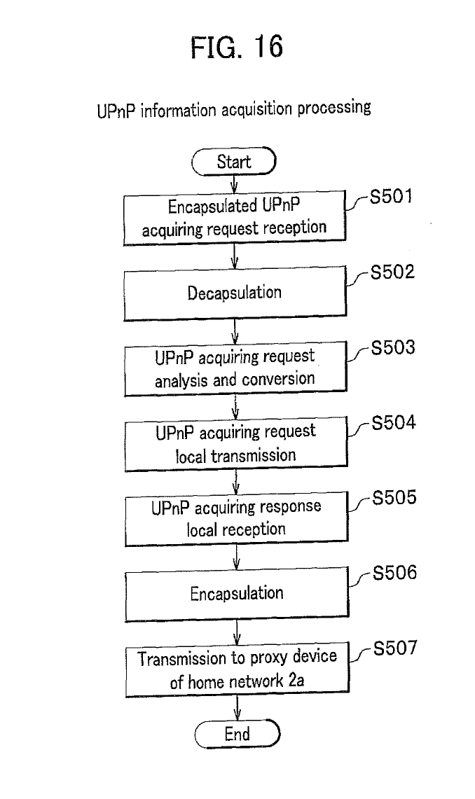

The proxy device 4b which received the encapsulated UPnP acquiring request (S5: described later by referring to FIG. 16) performs UPnP information acquiring. At Step S5, the proxy device 4b transmits the decapsulated UPnP acquiring request to the DLNA-compliant device 6c. The DLNA-compliant device 6c which received the UPnP acquiring request transmits a UPnP acquiring response to the proxy device 4b.

The proxy device 4b encapsulates the received UPnP acquiring response and then transmits this encapsulated UPnP acquiring response to the Internet 3.

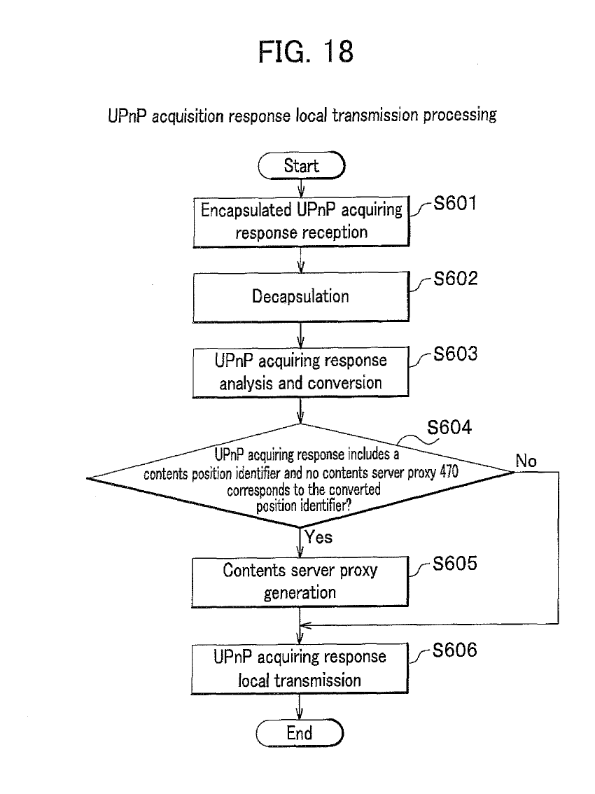

The proxy device 4a which received the encapsulated UPnP acquiring response performs UPnP acquiring response local transmission processing (S6: described later by referring to FIG. 18). The proxy device 4a transmits the UPnP acquiring response decapsulated at Step S6 to the DLNA-compliant device 6a.

Now, FIG. 4B will be described.

The DLNA-compliant device 6a which received the UPnP acquiring response transmits a contents acquiring request to the proxy device 4a.

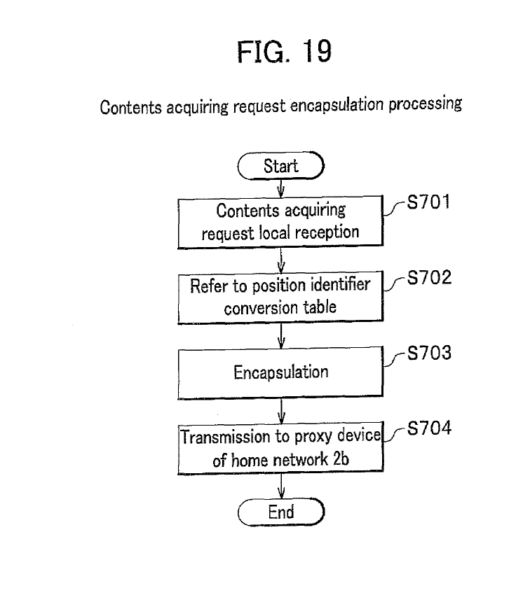

The proxy device 4a which received the contents acquiring request performs contents acquiring request encapsulation processing (S7: described later by referring to FIG. 19). The proxy device 4a transmits the contents acquiring request encapsulated at Step S7 to the Internet 3.

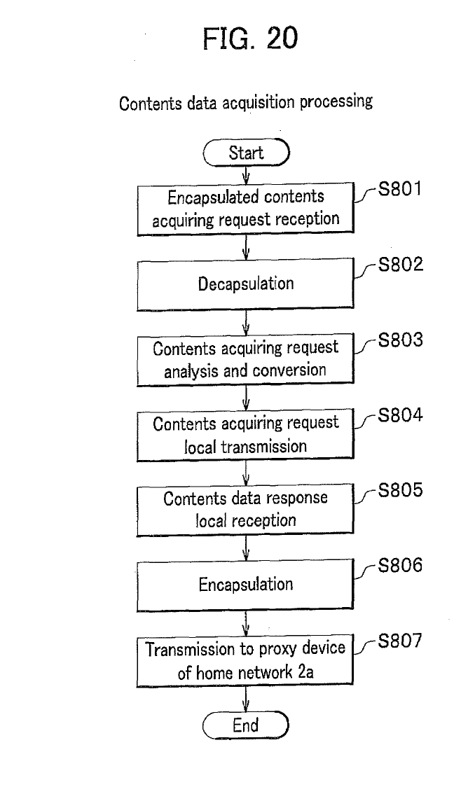

The proxy device 4b which received the contents acquiring request performs contents data acquisition processing (S8: described later by referring to FIG. 20). The proxy device 4b transmits the contents acquiring request decapsulated at Step S8 to the DLNA-compliant device 6c. The DLNA-compliant device 6c which received the contents acquiring request transmits a contents data response including contents data to the proxy device 4b. Then, the proxy device 4b encapsulates the received contents data and then transmits this encapsulated contents data to the Internet 3.

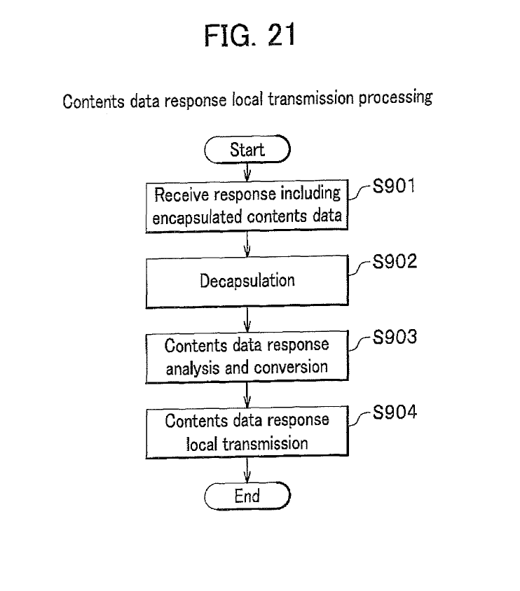

The proxy device 4a which received the encapsulated contents data performs contents data response local transmission processing (S9: described later by referring to FIG. 21). The proxy device 4a transmits the contents data response decapsulated at Step S9 to the DLNA-compliant device 6a. Then, the DLNA-compliant device 6a which received the contents data response reproduces contents data included in the contents data response.

### (Search Message Encapsulation Processing: S1)

Hereinafter, while referring to FIG. 1, FIG. 2, and FIG. 4 (FIG. 4A and FIG. 4B), the details of processing examples of Step S1 through Step S9 of FIG. 4 will be described.

FIG. 5 is a flowchart showing a flow of a search message encapsulation processing example of Step S1 of FIG. 4A.

The SSDP local communicator 401 of the proxy device 4a locally receives a search message multicast-transmitted to the LAN 7a of the home network 2a to which the proxy device 4a is connected from the DLNA-compliant device 6a (S101). Herein, the local reception means reception of information from a device in a local network in which the proxy device itself is located.

Then, the encapsulation processor 410 performs encapsulation by adding SSDP as a protocol name and a position identifier including an address and a port number of the DLNA-compliant device 6a which transmitted the search message to the search message (S102).

Further, the remote proxy communicator 400 transmits the search message encapsulated at Step S102 to the proxy device 4b connected to the LAN 7b of the home network 2b connected via the Internet 3, via the home router 5b (S103).

At Step S103, in actuality, the search message is also transmitted to other proxy devices 4 connected to the Internet 3, however the description on the processing is made focusing on the proxy device 4b among many proxy devices 4.

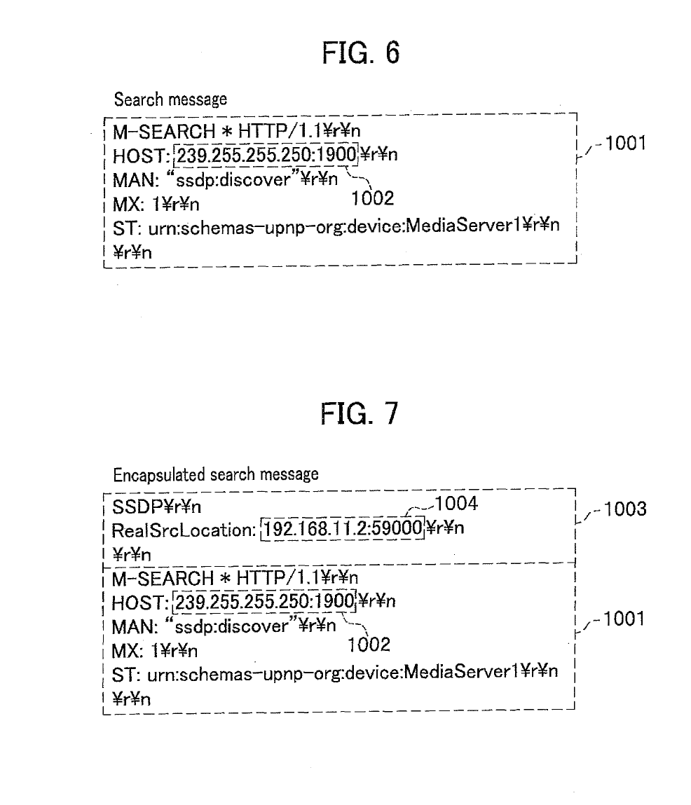

FIG. 6 is a diagram showing a detailed example of the search message transmitted from the DLNA-compliant device at Step S101 of FIG. 5.

As shown in FIG. 6, the search message 1001 includes a position identifier 1002 of a transmission destination. The position identifier 1002 at this stage is a position identifier which targets devices (in the example of FIG. 1, the DLNA-compliant device 6b and the proxy device 4a) in the home network 2a. Therefore, the DLNA-compliant device 6a transmits the search message 1001 including the position identifier 1002 to the DLNA-compliant device 6b, the proxy device 4a, and the home router 5a.

FIG. 7 is a diagram showing a detailed example of the search message encapsulated at Step S102 of FIG. 5.

The encapsulation processor 410 of the proxy device 4a performs encapsulation by adding a header 1003 including a position identifier 1004 of the DLNA-compliant device 6a as a transmission source to the search message 1001 including the position identifier 1002 shown in FIG. 6.

### (DLNA Local Search Processing: S2)

FIG. 8 is a flowchart showing a flow of a DLNA local search processing example at Step S2 of FIG. 4A.

The remote proxy communicator 400 of the proxy device 4b receives the encapsulated search message from the proxy device 4a (S201).

Then, the decapsulation processor 420 performs decapsulation by removing the added header (S202), and the dispatch processor 430 delivers the decapsulated search message to the SSDP message analysis and conversion processor 402.

Next, the SSDP message analysis and conversion processor 402 analyzes the delivered search message (S203) to check whether a position identifier that needs to be converted is included in the search message. Normally, the search message includes no position identifier that needs to be converted, so that the processing of position identifier conversion is not performed at Step S203.

The SSDP local communicator 401 multicast-transmits the search message delivered from the SSDP message analysis and conversion processor 402 to the LAN 7b (search message local transmission: S204).

Then, the SSDP local communicator 401 waits for a predetermined period of time for a response to the search message locally transmitted at Step S204 from the DLNA-compliant device 6c or the DLNA-compliant device 6d. In this explanation, it is assumed that the SSDP local communicator 401 locally receives a search response from, for example, the DLNA-compliant device 6c (S205).

Then, the encapsulation processor 410 encapsulates the search response locally received at Step S205 by adding, as a header, SSDP as a protocol name, information of an IP address and a port number of the DLNA-compliant device 6c which transmitted the search response as a position identifier of a true transmission source, and information of an IP address and a port number of the DLNA-compliant device 6a which originally transmitted the search message as a position identifier of a true receiving destination (S206).

Next, the remote proxy communicator 400 transmits the encapsulated search response to the proxy device 4a of the home network 2a (S207).

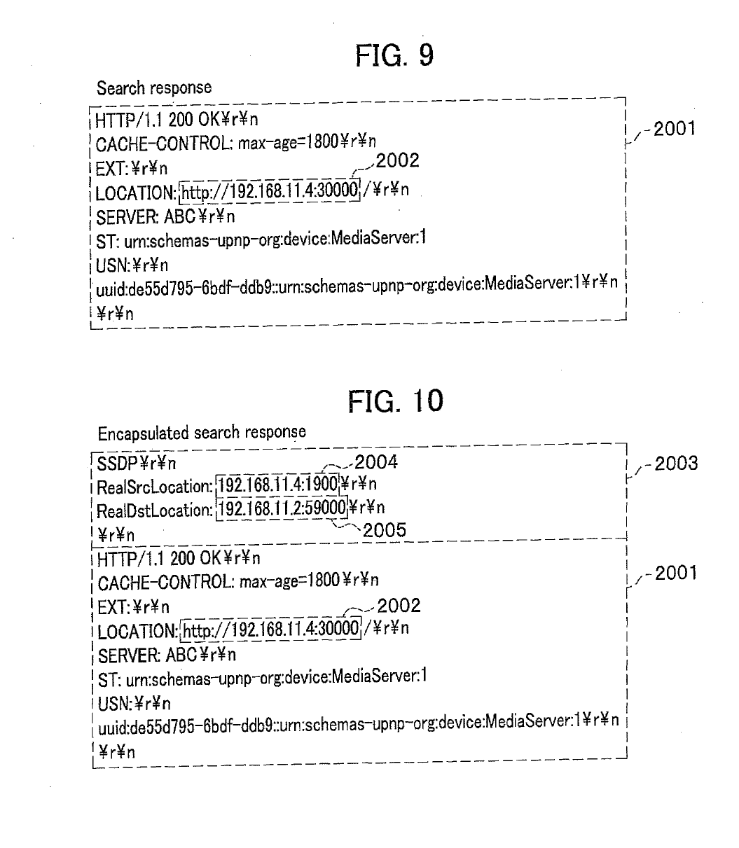

FIG. 9 is a diagram showing an example of the search response transmitted from the DLNA-compliant device at Step S205 of FIG. 8.

The SSDP local communicator 401 of the proxy device 4b receives the search response 2001 from the DLNA-compliant device 6c. The position identifier 2002 included in the search response 2001 is a position identifier of the DLNA-compliant device 6c of a transmission source.

FIG. 10 is a diagram showing a detailed example of the search response encapsulated at Step S206 of FIG. 8.

Encapsulation is performed by adding a header 2003 to the search response 2001 including the position identifier 2002 of the DLNA-compliant device 6c shown in FIG. 9.

The header 2003 includes a true transmission source position identifier 2004 (position identifier of the DLNA-compliant device 6c) and a true transmission destination position identifier 2005 (position identifier of the DLNA-compliant device 6a).

The true transmission destination position identifier 2005 can be included in the header 2003 by storing the position identifier 1004 of FIG. 7 in the proxy device 4b.

### (Search Response Local Transmission Processing: S3)

FIG. 11 is a flowchart showing a flow of a search response local transmission processing example at Step S3 of FIG. 4A.

The remote proxy communicator 400 of the proxy device 4a receives an encapsulated search response from the proxy device 4b (S301).

Next, the decapsulation processor 420 removes an encapsulated portion added to the search response received at Step S301 (decapsulation: S302).

Subsequently, the dispatch processor 430 delivers the decapsulated search response to the SSDP message analysis and conversion processor 402.

Then, the SSDP message analysis and conversion processor 402 analyzes the delivered search response and finds the position identifier including the IP address and the port number of the DLNA-compliant device 6c included in the search response. This position identifier is the position identifier of the DLNA-compliant device 6c in another home network 2 (home network 2b), so that it is not valid in the home network 2a. Therefore, the SSDP message analysis and conversion processor 402 converts the IP address in this position identifier into an IP address of the proxy device 4a itself, and converts the port number into an arbitrary port number of the proxy device 4a without overlapping (S303). Then, the SSDP message analysis and conversion processor 402 stores the correspondence between the position identifiers before and after being converted in the position identifier conversion table 440.

The SSDP proxy 450 judges whether there is (generated) an UPnP device proxy 460 corresponding to the converted position identifier (S304). At Step S304, when it is judged that there is no corresponding UPnP device proxy (S304=No), the processing proceeds to Step S305, and in the case where a corresponding UPnP device proxy 460 has been generated (S304=Yes), the processing proceeds to Step S306.

The UPnP device proxy generator 403 newly generates an UPnP device proxy 460 for response corresponding to the converted position identifier (S305).

Then, the SSDP local communicator 401 locally transmits the search response including the converted position identifier to the DLNA-compliant device 6a indicated by the true transmission destination position identifier (S306).

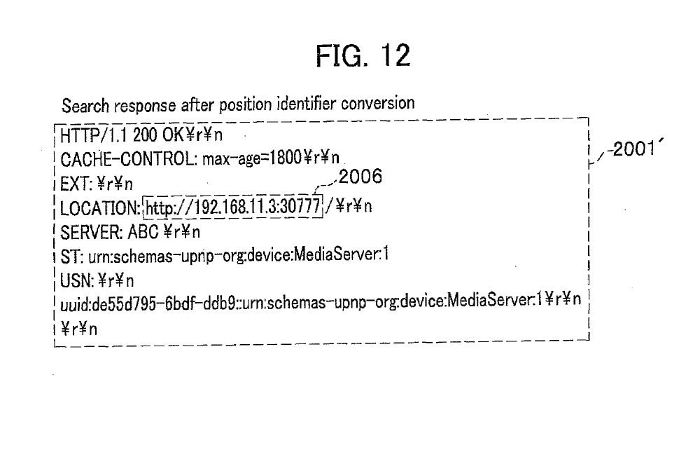

FIG. 12 is a diagram showing a detailed example of the search response including the position identifier converted at Step S303 of FIG. 11.

In the search response 2001′, the position identifier 2002 of the search response 2001 of FIG. 10 is converted into the position identifier 2006.

The position identifier 2002 of FIG. 10 is the position identifier of the DLNA-compliant device 6c of the home network 2b, and it cannot be used in the home network 2a. Therefore, the SSDP message analysis and conversion processor 402 converts the position identifier 2002 of FIG. 10 into the position identifier 2006 of the proxy device 4a. Herein, “192.168.11.3” of the position identifier 2006 indicates the address of the proxy device 4a in the home network 2a. “30777” of the position identifier 2006 is an arbitrary port number of the proxy device 4a without overlapping. The SSDP message analysis and conversion processor 402 associates the position identifier 2002 (see FIG. 10) before being converted with the position identifier 2006 after being converted and stores the relationship between the position identifier 2002 and the position identifier 2006 in the position identifier conversion table 440.

### (UPnP Acquiring Request Encapsulation Processing: S4)

FIG. 13 is a flowchart showing a flow of UPnP acquiring request encapsulation processing at Step S4 of FIG. 4A. The processings of Step S401 and Step S402 shown in FIG. 13 are performed by the UPnP device proxy 460 for response.

The UPnP local communicator 404 of the proxy device 4a locally receives a request (UPnP acquiring request) for acquiring UPnP information from the DLNA-compliant device 6a (S401).

Next, the UPnP message analysis and conversion processor 405 refers to the position identifier conversion table 410 (S402) and acquires the position identifier including the IP address and the port number of the DLNA-compliant device 6c of the home network 2b corresponding to the UPnP device proxy 460.

Then, the encapsulation processor 410 encapsulates the UPnP information acquiring request received at Step S401 by adding the position identifier of the DLNA-compliant device 6a (true request transmission source) which transmitted the UPnP acquiring request, the position identifier (position identifier of true request transmission destination: DLNA-compliant device 6c) acquired at Step S402, and an identifier by which the UPnP device proxy 460 executing the processing now can be uniquely identified (S403).

Then, the remote proxy communicator 400 transmits the UPnP acquiring request encapsulated at Step S403 to the proxy device 4b of the home network 2b (S404).

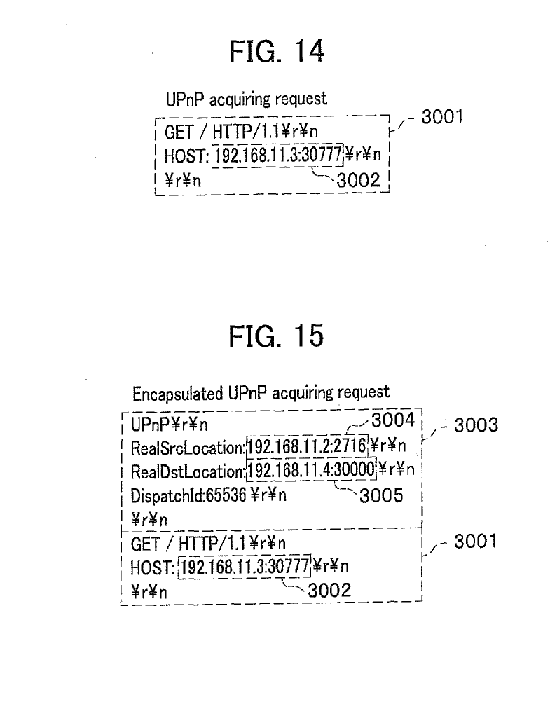

FIG. 14 is a diagram showing an example of the UPnP acquiring request received at Step S401 of FIG. 13.

The UPnP acquiring request 3001 includes a position identifier 3002 of the proxy device 4a. Herein, the position identifier 3002 is the same position identifier as the position identifier 2006 shown in FIG. 12.

FIG. 15 is a diagram showing an example of the UPnP acquiring request encapsulated at Step S403 of FIG. 13.

As shown in FIG. 15, encapsulation is performed by adding a header 3003 to the UPnP acquiring request 3001 including the position identifier 3002.

The header 3003 includes a position identifier 3004 of the DLNA-compliant device 6a as a true request transmission source, a position identifier 3005 of the DLNA-compliant device 6c as a true request transmission destination, and an identifier by which the UPnP device proxy 460 which executed the processing can be uniquely identified.

The position identifier 3005 is acquired by searching in the position identifier conversion table 440 by the UPnP message analysis and conversion processor 405.

### (UPnP Information Acquisition Processing: S5)

FIG. 16 is a flowchart showing a flow of a UPnP information acquisition processing example at Step S5 of FIG. 4A. The processings of Steps S503 through S505 shown in FIG. 16 are performed by the UPnP device proxy 460 for request.

The remote proxy communicator 400 of the proxy device 4b receives the encapsulated UPnP acquiring request (S501).

Then, the decapsulation processor 420 decapsulates the received UPnP acquiring request (S502) to acquire the true transmission source position identifier, the true transmission destination position identifier, and the identifier by which the UPnP device proxy 460 can be uniquely identified.

Next, the dispatch processor 430 delivers the decapsulated UPnP information acquiring request to the UPnP message analysis and conversion processor 405 of the UPnP device proxy 460.

Then, the UPnP message analysis and conversion processor 405 analyzes whether a position identifier invalid in the LAN 7b to which the proxy device 4b is connected is included in the delivered UPnP acquiring request, and when it is included, converts it into a valid position identifier (S503). As a detailed example of analysis, for example, destination IP address and port number according to a HOST header in HTTP may be included in the UPnP acquiring request. In such a case, the UPnP message analysis conversion processor 405 rewrites this position identifier into a position identifier of the true transmission destination (DLNA-compliant device 6c) included in the encapsulated UPnP acquiring request received at Step S501. When the destination IP address and port number are not included, the UPnP message analysis and conversion processor 405 does not perform the position identifier conversion processing.

Next, the UPnP local communicator 404 locally transmits the UPnP acquiring request including the position identifier converted at Step S503 to the DLNA-compliant device 6c (true transmission destination) connected to the LAN 7b (S504).

Then, after waiting for a predetermined period of time, the UPnP local communicator 404 locally receives a response (UPnP acquiring response) including UPnP information of the DLNA-compliant device 6c to the UPnP information acquiring request locally transmitted at Step S504 (S505).

Then, the encapsulation processor 410 performs encapsulation processing by adding to the UPnP acquiring response, as a header, UPnP as a protocol name, an IP address and a port number of the DLNA-compliant device 6c as a position identifier of the true transmission source, and a position identifier of the true transmission source (DLNA-compliant device 6a) acquired at S502 as a position identifier of the true transmission destination, and the identifier acquired at S502 by which the UPnP device proxy 460 can be uniquely identified (S506).

Next, the remote proxy communicator 400 transmits the encapsulated UPnP acquiring response to the proxy device 4a of the home network 2a (S507).

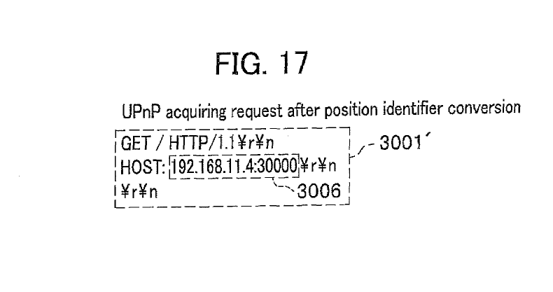

FIG. 17 is a diagram showing an example of the UPnP acquiring request after the position identifier is converted at Step S503 of FIG. 16.

In the UPnP acquiring request 3001′, the position identifier 3002 of the UPnP acquiring request 3001 shown in FIG. 15 is converted into a position identifier 3006.

Conversion into the position identifier 3006 is performed by the UPnP message analysis and conversion processor 405 by converting the position identifier 3002 of FIG. 15 into a position identifier 3005 of the true request transmission destination

### (DLNA-Compliant Device 6c of FIG. 15.

Processings after this are substantially the same as in FIG. 14, FIG. 15, and FIG. 17, so that drawings and descriptions of detailed examples of a message in each processing are omitted.

### (UPnP Acquiring Response Local Transmission Processing: S6)

FIG. 18 is a flowchart showing a flow of a UPnP acquiring response local transmission processing example at Step S6 of FIG. 4A. The processings of Steps S603 through S606 of FIG. 18 are performed by the UPnP device proxy 460.

First, the remote proxy communicator 400 of the proxy device 4a receives a response (UPnP acquiring response) including encapsulated UPnP information (S601).

Next, the decapsulation processor 420 decapsulates the encapsulated UPnP acquiring response (S602) to acquire the position identifier of the true transmission source (DLNA-compliant device 6c), the position identifier of the true transmission destination (DLNA-compliant device 6a), and an identifier by which the UPnP device proxy 460 can be uniquely identified.

Then, the dispatch processor 430 delivers the decapsulated UPnP acquiring response to the UPnP message analysis and conversion processor 405 of an appropriate UPnP device proxy 460 for response. Herein, “an appropriate UPnP device proxy 460” is the UPnP device proxy 460 for response generated at Step S305, indicated by the identifier by which the UPnP device proxy 460 can be uniquely identified.

Then, the UPnP message analysis and conversion processor 405 analyzes whether a position identifier invalid in the LAN 7a to which the proxy device 4a is connected is included in the UPnP acquiring response delivered at Step S602, and when it is included, converts it into a valid position identifier (S603). A detailed conversion method is the same as that of Step S503. Herein, when no invalid position identifier is included in the UPnP acquiring response, the UPnP message analysis and conversion processor 405 does not perform the processing. When a position identifier including an IP address and a port number of a contents storing site is included in the UPnP acquiring response, the UPnP message analysis and conversion processor 405 converts this position identifier into a position identifier composed of the IP address of the proxy device 4a itself and an arbitrary port number of the proxy device 4a without overlapping. The UPnP message analysis and conversion processor 405 stores the relationship of the position identifiers before and after being converted in the position identifier conversion table 440.

When a position identifier showing a contents storing site is converted at Step S603, the UPnP device proxy 460 judges whether or not the UPnP acquiring response includes a position identifier of the contents (position identifier including information on the contents storing site) and any contents server proxy 470 corresponds to the converted position identifier (S604). When UPnP acquiring response includes a contents position identifier and no contents server proxy 470 corresponds to the converted position identifier (S604=Yes), the UPnP device proxy 460 shifts the processing to Step S605. At Step S603, when position identifier conversion processing is not performed (no contents position identifier is included in the UPnP acquiring response) or when a contents server proxy 470 corresponding to the converted position identifier has already been present (S604=No), the UPnP device proxy 460 shifts the processing to Step S606.

The contents server proxy generator 406 dynamically generates a contents server proxy 470 for response in accordance with the position identifier converted at Step S603 (S605).

Then, the UPnP local communicator 404 locally transmits the UPnP response including the position identifier converted at Step S603 to the DLNA-compliant device 6a indicated by the position identifier of the true transmission destination (S606).

### (Contents Acquiring Request Encapsulation Processing: S7)

FIG. 19 is a flowchart showing a flow of a contents acquiring request encapsulation processing example of Step S7 of FIG. 4B. The processings of Step S701 and Step S702 shown in FIG. 19 are performed by the contents server proxy 470 for response.

The HTTP local communicator 407 of the proxy device 4a locally receives a request (contents acquiring request) for acquiring contents data from the DLNA-compliant device 6a (S701).

Then, the HTTP message analysis and conversion processor 407 refers to the position identifier conversion table 440 (S702) and acquires a position identifier including the IP address and the port number of the DLNA-compliant device 6c connected to the LAN 7b of the home network 2b, corresponding to the contents server proxy 470.

Next, the encapsulation processor 410 encapsulates the contents acquiring request by adding to the contents data acquiring request received at Step S701, a header including DLNA as a protocol name, the position identifier of the DLNA-compliant device 6a which transmitted the contents data acquiring request as a true request transmission source, and a position identifier of the acquired true request transmission destination (DLNA-compliant device 6c) (S703).

Then, the remote proxy communicator 400 transmits the encapsulated contents acquiring request to the proxy device 4b of the home network 2b (S704).

### (Contents Data Acquisition Processing: S8)

FIG. 20 is a flowchart showing a flow of a contents data acquisition processing example at Step S8 of FIG. 4B. The processings of Steps S803 through S805 of FIG. 20 are performed by the contents server proxy 470 for request.

The remote proxy communicator 400 of the proxy device 4b receives the encapsulated contents acquiring request transmitted from the proxy device 4a (S801).

Next, the decapsulation processor 420 decapsulates the encapsulated contents acquiring request (S802) to acquire the position identifier of the true transmission source (DLNA-compliant device 6a) and the position identifier of the true transmission destination (DLNA-compliant device 6c) included in the header.

The dispatch processor 430 delivers the decapsulated contents acquiring request to the HTTP message analysis and conversion processor 408 of the contents server proxy 470.

Then, the HTTP message analysis and conversion processor 408 analyzes whether a position identifier invalid in the LAN 7b to which the proxy device 4b is connected is included in the delivered contents acquiring request, and when an invalid position identifier is included, converts it into a valid position identifier (S803). For example, the contents acquiring request includes a destination IP address and port number according to the HOST header. In such a case, the HTTP message analysis and conversion processor 408 rewrites this position identifier into a position identifier of the true transmission destination (DLNA-compliant device 6c) acquired after Step S802. When no invalid position identifier is included in the contents acquiring request, the HTTP message analysis and conversion processor 408 does not perform the position identifier conversion processing.

Next, the HTTP local communicator 407 locally transmits the contents acquiring request obtained through the processing of Step S803 to the DLNA-compliant device 6c as the true transmission destination connected to the same LAN 7b (S804).

Then, after waiting for a predetermined period of time, the HTTP local communicator 407 locally receives a response to the contents acquiring request locally transmitted at Step S804 (contents data response) including contents data transmitted from the DLNA-compliant device 6c (S805).

Further, the encapsulation processor 410 encapsulates the contents data response by adding to the contents data response DLNA as a protocol name, the IP address and the port number of the DLNA-compliant device 6c which transmitted the contents data response as an identifier of the true transmission source, and a position identifier of the true transmission destination (DLNA-compliant device 6a) acquired at Step S802.

Then, the remote proxy communicator 400 transmits the contents data response encapsulated at Step S806 to the proxy device 4a of the home network 2a (S807).

### (Contents Data Response Local Transmission Processing: S9)

FIG. 21 is a flowchart showing a flow of a contents data response local transmission processing example of Step S9 of FIG. 4B. The processings of Step S903 and Step S904 shown in FIG. 21 are performed by the contents server proxy 470 for response.

First, the remote proxy communicator 400 of the proxy device 4a receives the encapsulated contents data response (S901).

Then, the decapsulation processor 420 decapsulates this encapsulated contents data response (S902) to acquire the position identifier of the true transmission source (DLNA-compliant device 6c) and the position identifier of the true transmission destination (DLNA-compliant device 6a).

Next, the dispatch processor 430 delivers the decapsulated contents data response to the HTTP message analysis and conversion processor 408 of an appropriate contents server proxy 470 for response. Herein, “an appropriate contents server proxy 470 for response” is a contents server proxy 470 for response corresponding to the port number converted at Step S603 which coincides with the port number that accepted this contents data response.

Then, the HTTP message analysis and conversion processor 408 analyzes whether or not a position identifier invalid in the LAN 7a to which the proxy device 4a is connected is included in the delivered contents data response, and when an invalid position identifier is included, converts it into a valid position identifier (S903). The detailed method of Step S903 is the same as that of Step S803. When no invalid position identifier is included, the HTTP message analysis and conversion processor 408 does not perform the processing.

Further, by the HTTP local communicator 407, the contents data response obtained through the processing of Step S903 is locally transmitted to the DLNA-compliant device 6a indicated by the position identifier of the true transmission destination (S904).

Then, the DLNA-compliant device 6a performs reproduction, etc., of the contents included in the received contents data response (S904).

### (Variation)

In the present embodiment, contents server proxies 470 are generated for processing conforming to the DLNA guidelines, however, when a message determined according to UPnP is used as in the case of device control, the contents server proxy generator 406 and the contents server proxies 470 may be omitted.

In the present embodiment, the message to be handled by the contents server proxy 470 is an HTTP message according to the DLNA guidelines, however, it may be a message conforming to another protocol.

Further, the contents server proxy 470 directly performs processing without converting the contents data, however, it may have functions for transcoding and contents data converting for trick play on the server side.

In the present embodiment, communication encoding and decoding are not mentioned, however, communication information may be encoded and decoded by the remote proxy communicator 400.

Further, in the present embodiment, exchange of a message including contents data between the proxy device 4a and the proxy device 4b is performed via the remote proxy communicator 400, however, it is also allowed that contents data is transmitted and received via another added communicator to which an original contents protection technique suitable for the contents characteristics is applied.

### (Effect)

Next, the effect of the present embodiment will be described with reference to FIG. 1.

According to the present embodiment, transmission and reception of a message between the DLNA-compliant device 6a or the DLNA-compliant device 6b of the home network 2a and the DLNA-compliant device 6c or the DLNA-compliant device 6d of the home network 2b which are originally incapable of communicating with each other is enabled by encapsulating the message.

Further, a position identifier invalid in the home network 2a in which the proxy device 4a itself is present, included in a message received via the Internet 3 is converted into a position identifier valid in this home network 2a, whereby the message transmitted from the DLNA-compliant device 6c can make the DLNA-compliant device 6a believe that the message was transmitted from the proxy device 4a. As a result, between the DLNA-compliant devices 6 present in the home network 2a and the home network 2b, a message according to the DLNA guidelines and UPnP can be exchanged. That is, it is not necessary that device information and service information of a UPnP-enabled device present in a home network are collected by a UPnP device proxy device connected to this home network and registered in advance in the other home network as in the case of the UPnP device proxy device described in Patent document 1.

Further, even without using SOAP, transmission and reception of a message according to the DLNA guidelines and UPnP are enabled.

Moreover, application to routers is not necessary, so that only by adding the proxy device 4 of this embodiment into the configurations of existing home networks 2, communication between the DLNA-compliant devices 6 in the different home networks 2 is enabled.

The embodiment according to the present invention has been explained as aforementioned. However, the embodiment of the present invention is not limited to those explanations, and those skilled in the art ascertain the essential characteristics of the present invention and cam make the various modifications and variations to the present invention to adapt it to various usages and conditions without departing from the spirit and scope of the claims.

What is claimed is:

1. A proxy device which transmits and receives information to and from an information appliance present within a first closed network, the proxy device capable of communicating with an open network, comprising:
an encapsulation processor that encapsulates the information that is capable of communication with the first closed network but incapable of communication with the open network, so as to allow the encapsulated information to be capable of communication with the open network;
a remote proxy communicator which transmits and receives the encapsulated information via the open network;
a decapsulation processor which decapsulates the encapsulated information; and
a local communicator which transmits the decapsulated information into the first closed network in which the proxy device itself is located.

2. The proxy device according to claim 1, further comprising:
a position identifier converter that converts a position identifier, which is included in the information received via the open network and is invalid within the first closed network where the proxy device is located, to be valid in the first closed network.

3. The proxy device according to claim 2, wherein
the information is one piece of collected information in a hierarchical structure, and the proxy device further comprises a processing generator that dynamically generates a process for processing information higher than the information in accordance with the converted position identifier.

4. The proxy device according to claim 2, wherein
the invalid position identifier is a position identifier of an information appliance present within a second closed network which is different from the first closed network where the proxy device itself is located, and
the valid position identifier is a position identifier of the proxy device itself.

5. The proxy device according to claim 1, wherein
the encapsulation processor encapsulates the information by adding to the information, as a header, a position identifier for an information appliance, which is a receiver and located within a second closed network different from the first closed network where the proxy device itself is located, as well as a position identifier of the information appliance in the first network where the proxy device itself is located.

6. A network system for allowing communication via an open network between
a first closed network including a first proxy device capable of accessing a first information appliance and
a second closed network including a second proxy device capable of accessing a second information appliance incapable of communicating with the first information appliance,
the first proxy device
encapsulating information, which is transmitted from the first information appliance and is capable of communication within the first closed network but incapable of communication with the open network, so as to allow the encapsulated information to be capable of communication with the open network;
transmitting the encapsulated information to the open network;
the second proxy device
decapsulating the encapsulated information received via the open network; and
transmitting the decapsulated information to the second information appliance to allow communication between the first information appliance and the second information appliance.

7. The network system according to claim 6, wherein
the second proxy device
converts a position identifier, which is included in the information received via the open network and invalid within the second closed network, to be valid in the second closed network.

8. A communication method for a plurality of proxy devices capable of transmitting and receiving information to and from information appliances in a plurality of closed networks, the closed networks capable of communicating with one another via an open network,
the method comprising steps of:
allowing a first proxy device of the plural proxy devices to perform
encapsulating the information capable of communication with a first closed network of the closed networks where the first proxy device itself is located but incapable of communicating with the open network, so as to allow the encapsulated information to be communicated with the open network,
transmitting the encapsulated information to a second proxy device of the plural proxy devices via the open network; and
allowing the second proxy device which receives the encapsulated information to perform
decapsulating the encapsulated information, and
transmitting the decapsulated information to a second closed network of the closed networks where the second proxy device itself is located.

9. The communication method according to claim 8, wherein
a position identifier, which is included in the information received via the open network and invalid within the second closed network where the second proxy device is located, is converted to be valid in the second closed network.
